(19) United States
(12) Patent Application Publication
(10) Pub. No.: US 2002/0052966 A1
(43) Pub. Date: May 2, 2002

(54) Service discovery protocol server

(75) Inventors: Manabu Isomura, Saitama (JP); Kiyohito Yoshihara, Saitama (JP); Shinji Motegi, Saitama (JP); Hiroki Horiuchi, Saitama (JP)

Correspondence Address: ARMSTRONG,WESTERMAN & HATTORI, LLP, 1725 K STREET, NW., SUITE 1000, WASHINGTON, DC, 20006, US

(73) Assignee: KDDI Corporation, Tokyo (JP)

(21) Appl. No.: 10/025,611

(22) Filed: Dec. 26, 2001

(30) Foreign Application Priority Data
Dec. 27, 2000 (JP) 397001/2000

(51) Int. Cl. G06F 15/173; G06F 15/16

(52) U.S. Cl. 709/230; 709/226

(57) ABSTRACT

A service discovery protocol server for discovering a service provided by an apparatus using a service discovery protocol, from another apparatus using a service discovery protocol different from the service discovery protocol has a common database for storing service information on a plurality of service discovery protocols, written in a common format, and a handler unit for handling one of the plurality of service discovery protocols. The handler unit includes a conversion unit for mutually converting service information between a format used in the one service discovery protocol handled in this handler unit and the common format.

### FIELD OF THE INVENTION

The present invention relates to a SDP (Service Discovery Protocol) server. More particularly, the present invention relates to a server for enabling a discovery of a service provided by an apparatus or appliance using one SDP from another appliance using other SDP.

### DESCRIPTION OF THE RELATED ART

Recently, in order to communicate home appliances with a computer, various SDPs are proposed from many organizations. The SDP automatically collects and manages service information on the appliances, and controls the appliances according to the request of a user. Even if many appliances are used, therefore the user does not need to setup and to manage the respective service information. The appliances are, for example, a PDA (Personal Digital Assistant), a printer, a TA (Terminal Adapter), a CD (Compact Disc) drive, a cellular telephone and a digital camera.

The SDP may be, for example, JINI proposed by SUN Microsystems, UPnP proposed by UPnP forum, Salutation proposed by Salutation consortium, Bluetooth SDP profile proposed by Bluetooth SIG, or SLP proposed by IETF.

A typical conventional, method for discovering an appliance by SDP will be described hereinafter. At first, the appliance will broadcast a position information indicating its location via a cable or radio network. The position information will be detected by a SDP control unit provided in a computer or in another appliance. The SDP control unit may be, for example, a look-up service on JINI. Then, the SDP control unit will send a response message to the appliance who broadcasted the position information. Thus, the appliance will send back service information containing service attributes to the SDP control unit. As a result, the SDP control unit will be able to register the received service information. Since the SDP control unit operates as a server for providing the service information on SDP, it is possible to discover existing many appliances and to collect the service information provided by the appliances. The service attributes may be, for example, a service name, a description of the service, a version, a maker, and a location for providing service.

In another conventional method, the SDP control unit will send an inquiry message by multicasting to appliances on the network. Thus, the SDP control unit will receive a response message from the appliance and it is possible to discover the service information.

In a further conventional method, the SDP control unit will send an inquiry message to a service discovery server using the same SDP. Then, the SDP control unit will be able to receive all service information stored in the server

However, these SDPs are incompatible with each other. Therefore, there is a problem that an appliance using one SDP cannot discover a service provided by another appliance using different SDP.

### SUMMARY OF THE INVENTION

It is therefore an object of the present invention to provide a SDP server, whereby an appliance using one SDP can discover a service provided by another appliance using different SDP.

According to the present invention, particularly, a SDP server provided by an apparatus using a SDP, from another apparatus using a different SDP has a common database for storing service information on a plurality of SDPs, written in a common format, and a handler unit for handling one of the plurality of SDPs. The handler unit includes a conversion unit for mutually converting service information between a format used in the one SDP handled in this handler unit and the common format.

The SDP server according to the present invention can discover a service provided by one apparatus using a SDP, from another apparatus using a different SDP. Thus, the availability of SDP enhances. Furthermore, it can support easily to new SDP only by modifying the common database and the format conversion unit.

It is preferred that the service information is defined for each service attribute, and that the conversion unit converts the service information between one service attribute of the handler means and another service attribute of the common database. The one service attribute has the same semantic description as the another service attribute.

It is also preferred that the service attribute includes a service name, a vender name, a location and a service discovery protocol handler name.

It is preferred that the handler unit includes a service discovery protocol control unit, a communication protocol control unit and a communication unit.

Further objects and advantages of the present invention will be apparent from the following description of the preferred embodiments of the invention as illustrated in the accompanying drawings.

### BRIEF DESCRIPTION OF THE DRAWINGS

FIG. 1 shows a system configuration with a server for SDP according to the present invention;

FIG. 2 shows a functional block diagram of the server in FIG. 1;

FIG. 3 shows a mapping table of a common database in the server in FIG. 1;

FIG.4 shows a block diagram of a more concrete example of the server according to the present invention; and

FIG. 5 shows a mapping table of a common database in FIG. 4.

### DESCRIPTION OF THE PREFERRED EMBODIMENTS

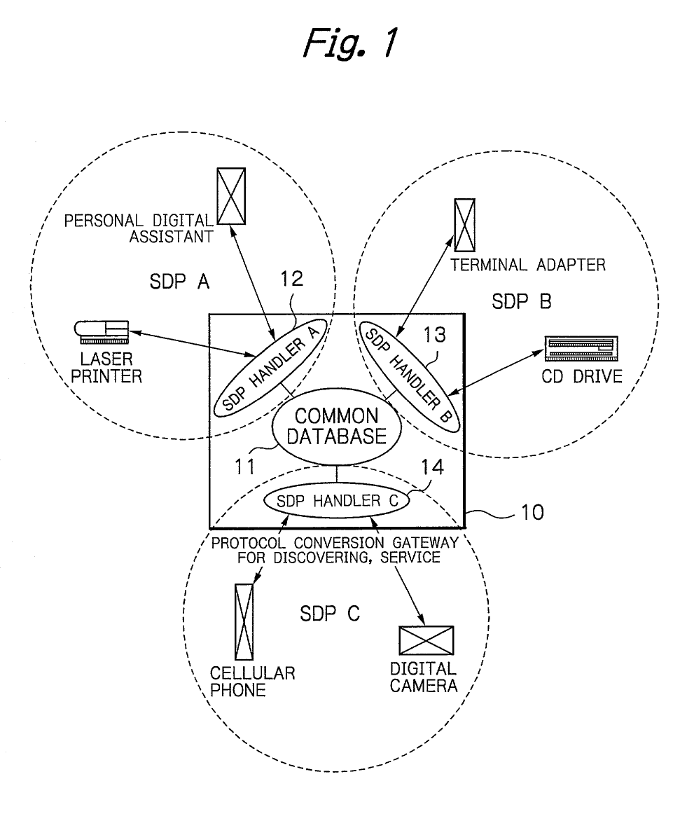

FIG. 1 illustrates a system with a server for SDP according to the present invention. As shown in the figure, the system has the server 10 and two or more (three in this figure) appliances using different SDPs A, B and C. The server 10 has a common database 11 and three SDP handlers 12 to 14.

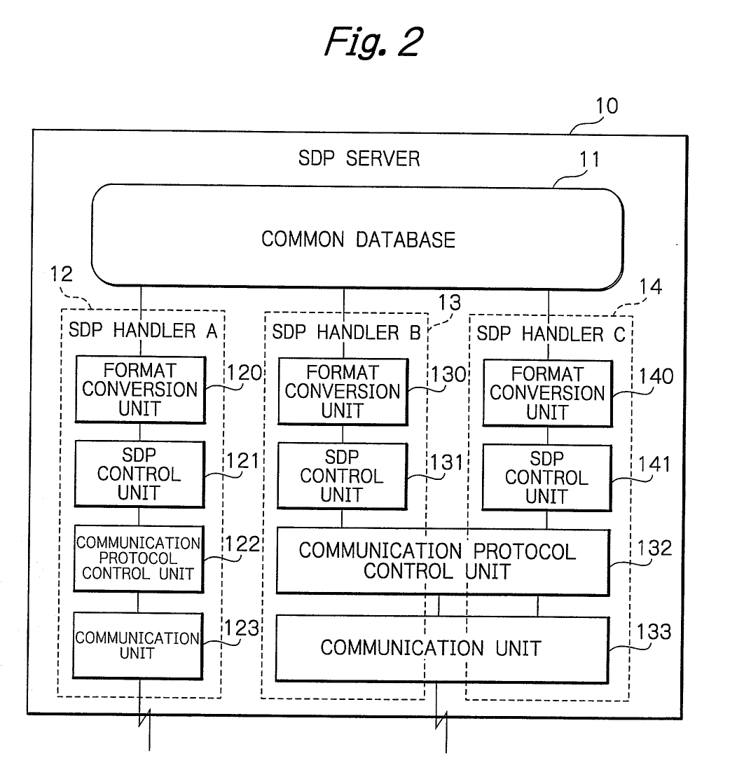

FIG. 2 functionally illustrates configuration of the server 10. As will be noted from this figure, the SDP. handlers 12 to 14 employ different SDPs A, B and C, respectively. The common database 11 stores service information for service attributes provided by the SDP handler 12 to 14. The service information stored in the common database 11 is written in a common format that can be understood by all SDP handlers.

Each of the SDP handlers 12 to 14 includes a communication unit 123 or 133 for communicating through a cable such as Ethernet or through a radio such as Bluetooth, a communication protocol control unit 122 or 132 that is a high order layer of the communication unit, a SDP control unit 121, 131 or 141 for executing the SDP, and a format conversion unit 120, 130 or 140 for converting a SDP format of the service information into the common format or the common format into the SDP format.

The communication unit 133 and the communication protocol control unit 132 may be shared by different SDP handlers.

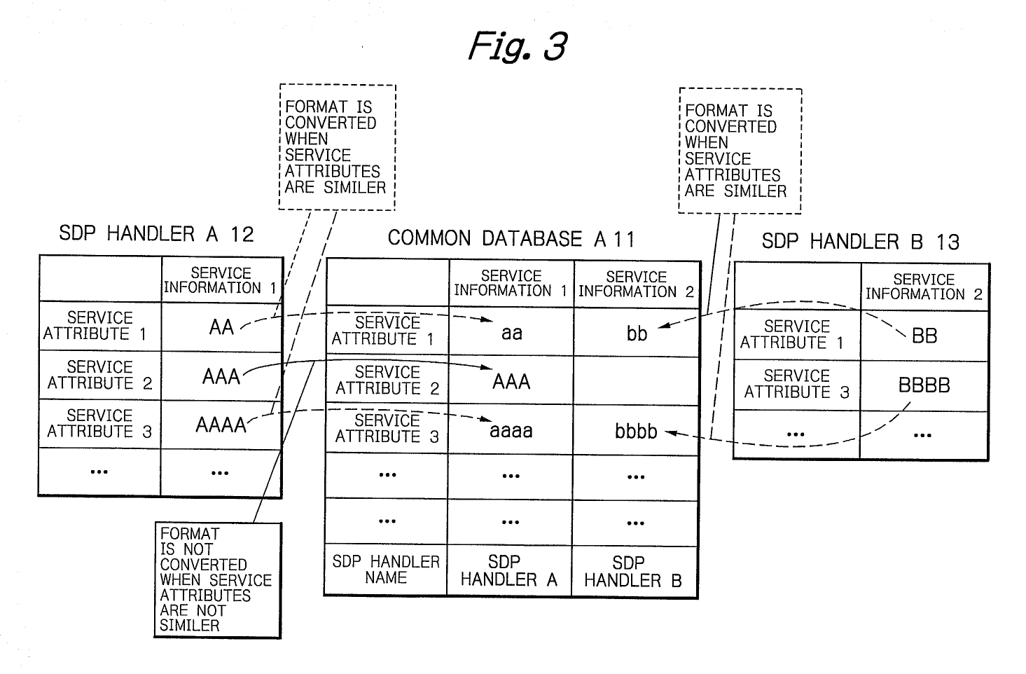

FIG. 3 illustrates contents of the service information actually stored in the common database 11 and relationship of the contents with respect to that in the SDP handlers 12 and 13. The format conversion unit converts the format of the service information into the common format when service attributes of the SDP handler are similar to that of the common database, in other words semantic description of service attributes of the SDP handler are the same as that of the common database, and also the format of the service information for the service attribute in the SDP handler differs from the format of the service information in the common database. The format conversion unit sends the converted service information to the common database 10.

In case of FIG. 3, the service attributes 1 and 3 of the SDP handler A are similar to the service attributes 1 and 3 of the common database. Thus, the service information “AA” of the SDP handler is converted into the service information “aa” written in the common format, and this service information “aa” for the service attribute 1 is stored in the common database 11. Likewise, the service information “AAAA” of the SDP handler A is converted into the service information “aaaa” written in the common format, and this service information “aaaa” for the service attribute 3 is stored in the common database 11.

When a format of the service information for the service attribute in the SDP handler is the same as the format of the service information in the common database, the format conversion unit does not convert the service information, and the format conversion unit sends the original service information to the common database 11.

Also, when the service attributes in the SDP handler are not similar to that in the common database 11, the format conversion unit does not convert the service information, and the format conversion unit sends the service information with the service attributes written in the original format.

In case of FIG. 3, the service attributes 2 are included only in SDP A, and thus the common database 11 stores the service information “AAA” with the service attributes 2 written in the original format.

As will be noted from the above-description, the common database 11 can store different service information discovered by two or more SDP handlers. The stored service information in the common database 11 may be modified by generation, alteration and/or erasure of the service provided by the appliances. The common database 11 also stores a service attribute for recoding an identifier of the SDP handler discovered in conjunction with the service information.

Each SDP handler operates in its inherent SDP as a server for providing service information. When a SDP handler using one SDP receives an inquiry message of service information from an appliance using a different SDP, a format conversion unit in this SDP handler will convert a service information written in a common format and stored in the common database into a format of the different SDP, and then will send back as a response message the converted service information. Therefore, the inquired appliance will be able to obtain not only the service information discovered by its SDP, but also the service information discovered by other SDP stored in the common database.

The inquiry message may include name of service information requested. The format conversion unit will convert the name of service information into the common format, and retrieve or search the common database. Then, the format conversion unit will convert the searched result from the common database into a format in a SDP used in the inquired appliance, and the server will send the converted searched result to the inquired appliance.

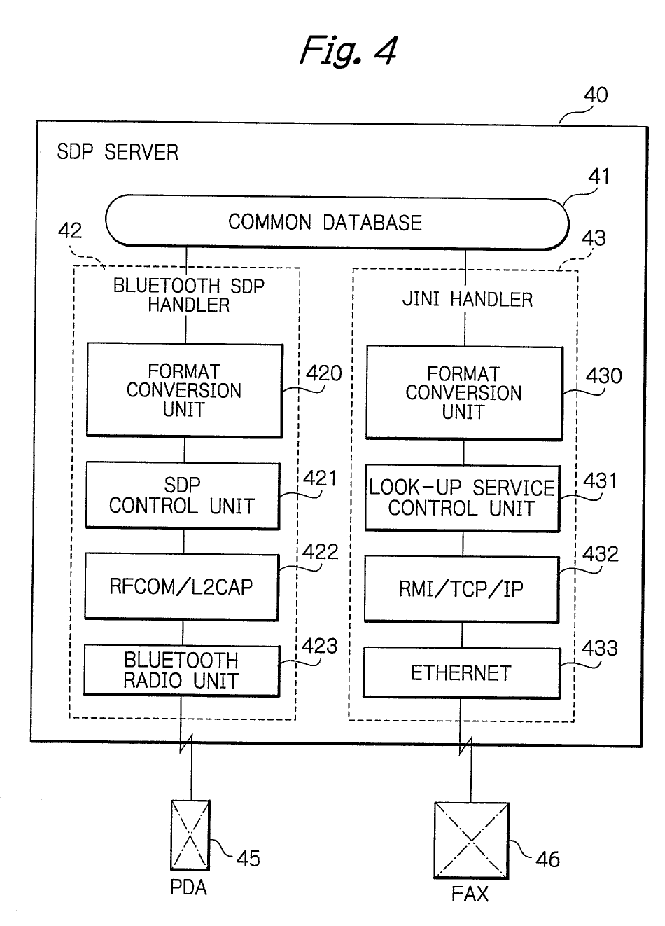

FIG. 4 functionally illustrates configuration of a more concrete example of a server according to the present invention.

In this example, as shown the figure, a PDA 45 supporting Bluetooth can use a service of a FAX 46 supporting JINI through the server 40. Namely, the server 40 can communicate with the Bluetooth capable PDA 45 and the JINI capable FAX. In order to enabling this function, the server 40 has a common database 41, a SDP handler 42 supporting Bluetooth and a SDP handler 43 supporting JINI.

The Bluetooth SDP handler 42 has a format conversion unit 420 according to the present invention, a SDP control unit 421, a RFCOM/L2CAP 422, and a physical layer 423 of Bluetooth radio unit, in this sequential order from a high order layer. Furthermore, the JINI SDP handler 43 has a format conversion unit 430 according to the present invention, a look-up service control unit 431, a transport layer 432 of RMI (Remote Method Invocation)/TCP/IP, and a physical layer 433 of Ethernet, in this sequential order from a high order layer.

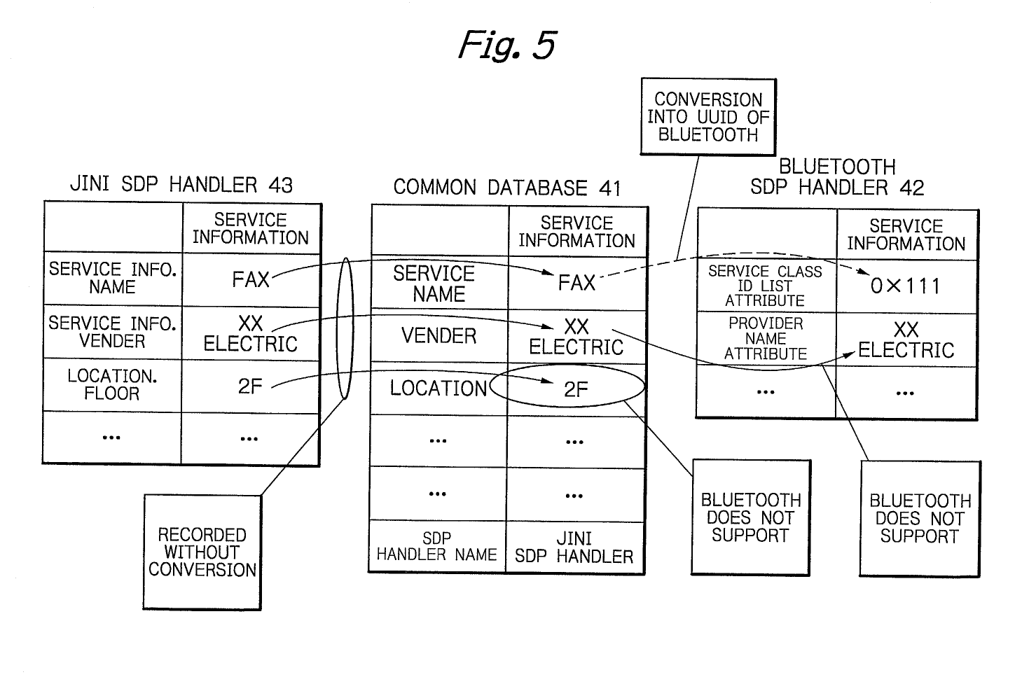

FIG. 5 illustrates contents of the service information actually stored in the common database 41 and relationship of the contents with respect to that in the SDP handlers 42 and 43.

The name item “FAX” of ServiceInfo entry on JINI is recorded at a service attribute “service name” in a mapping table of the common database 41. The vender item “xx electric” of ServiceInfo entry on JINI is recorded at a service attribute “vender” in the mapping table. The floor item “2F” of Location entry on JINI is recorded at a service attribute “location” in the mapping table.

The Bluetooth SDP handler 42 has a function as a SDP server using Bluetooth, and receives the service discovery request from the Bluetooth capable PDA 45.

Then, the Bluetooth SDP handler 42 will receive service information of FAX recorded by the JINI SDP handler 43, from the common database 41. Since a format “FAX” of service information specified in Bluetooth SDP differs from a format “0x1111” of service information used in the common database 41, the format conversion unit 420 will convert the format of service information.

This conversion of format will be executed as follows, for example:

The service attribute “service name” in the mapping table of the common database 41 is mapped with service Class Id List Attribute of Bluetooth. However, service Class Id List Attribute is UUID of 16-bit. Therefore, the format conversion unit 420 will convert the character string “FAX” recorded as a service information at the service attribute “service name” in the common database 41, to UUID=0x1111 for indicating FAX profile of Bluetooth.

The service attribute “vender” in the common database 41 corresponds to provider Name Attribute of Bluetooth. Since a string type of the service attribute “vender” in the common database is the same as that of the providerNameAttribute of Bluetooth, “xx electric” is inputted in providerNameAttribute in the Bluetooth SDP handler 42 without conversion.

The service attribute “location” in the common database 41 is not used because the service attributes corresponding to the service attribute “location” does not exist in Bluetooth SDP.

The Bluetooth SDP handler 42 then transmits to the PDA 45 the converted service information from the format of the common database 10 as mentioned above. Thus, the PDA only supporting Bluetooth can discover a service of the JINI capable FAX through the server 40.

Many widely different embodiments of the present invention may be constructed without departing from the spirit and scope of the present invention. It should be understood that the present invention is not limited to the specific embodiments described in the specification, except as defined in the appended claims.

What is claimed is:

1. A service discovery protocol server for discovering a service provided by an apparatus using a service discovery protocol, from another apparatus using a service discovery protocol different from said service discovery protocol, said server comprising;
a common database for storing service information on a plurality of service discovery protocols, written in a common format; and
a handler means for handling one of said plurality of service discovery protocols, said handler means including a conversion means for mutually converting service information between a format used in said one service discovery protocol handled in this handler means and said common format.

2. A server as claimed in claim 1, wherein said service information is defined for each service attribute, and wherein said conversion means converts said service information between one service attribute of said handler means and another service attribute of said common database, said one service attribute having the same semantic description as said another service attribute.

3. A server as claimed in claim 2, wherein said service attribute includes a service name, a vender name, a location and a service discovery protocol handler name.

4. A server as claimed in claim 1, wherein said handler means includes a service discovery protocol control means, a communication protocol control means and a communication means.
